(19) United States
(12) Patent Application Publication
(10) Pub. No.: US 2006/0034997 A1
(43) Pub. Date: Feb. 16, 2006

(54) Instant roux

(76) Inventors: Janet M. Carver, Lambertville, NJ (US); Robert C. Kendall, Flemington, NJ (US); Ghislaine Joly, Bridgewater, NJ (US); Maruja Oswald, Ringoes, NJ (US)

Correspondence Address: David P. LeCroy, NATIONAL STARCH AND CHEMICAL COMPANY, P.O. Box 6500, Bridgewater, NJ, 08807-0500, US

(21) Appl. No.: 10/918,991

(22) Filed: Aug. 16, 2004

(51) Int. Cl. A23L 1/40

(52) U.S. Cl. 426/589

(57) ABSTRACT

This invention relates to an instant roux comprising co-processed modified starch and flour and fat. In addition, the invention relates to the process for providing such “ready-for-use” compositions and the improved food products prepared from the co-processed compositions.

### BACKGROUND OF THE INVENTION

1. Technical Field.

This invention relates to a thickener or thickening composition that includes a “co-processed” combination of modified starch, flour and fat for use in foods. In addition, the invention relates to the process for providing such “ready-for-use” compositions and the improved food products prepared from the co-processed compositions. More particularly, the present invention is directed toward a thickening composition useful as an instant roux.

2. Background Information.

A roux is known in the art as a mixture of equal amounts of flour and fat for use as a thickening agent in a soup or sauce. Traditionally, roux is prepared by melting fat, e.g., butter, in a pan and carefully adding flour while blending the two components. Cooking the flour in fat causes the flour granules to break. When liquid is added, the flour granules absorb the liquid, thickening the sauce. The flour is also blended with fat because flour clumps and lumps if mixed in a sauce by itself. In preparing a roux melted butter and flour are typically mixed together and cooked until bubbly. The flour needs to be stirred constantly during this preparation in order to keep it from lumping. The process is labor intensive and requires great skill, but produces a roux with excellent thickening properties and a desirable taste and mouthfeel.

Roux comes in varying shades from off-white to the much darker brown shades. There are four names that are generally associated with these varying shades—white, blond, brown and dark. The color produced depends on the time and temperature used in cooking the flour. Flour cooked over a low heat for a long period of time will be light in color. Flour cooked over a high heat quickly will be darker, have a stronger flavor, and will not be a strong a thickener as a lighter roux. This thickening mixture can be browned very deeply for used in food dishes such as étouffée and brown sauce. If not browned, the thickener can be used as a base for béchamel, velouté or white sauce. Still, these thickeners are not suitable for large-scale commercial production. Also, the products cannot be further processed for use in dried foodstuffs.

The use of starches, both unmodified and modified, in thickening agents presents long recognized problems, particularly for professionals in the food service industry. Unmodified starch-containing thickeners must be precooked before being used to increase the viscosity of cold or precooked foods. However, the use of a precooked, unmodified starch often imparts an undesirable stringiness to the texture of the food. While the addition of a modified starch can confer a satisfactory texture to cold or precooked foods, these foods do not provide the desirable taste and appearance of foods prepared from thickeners containing modified starches that have been precooked with flour. This is particularly true of foods such as gravies and soups that rely upon the traditional taste and opacity conveyed by an industry standard thickener containing cooked flour and/or modified starch.

Further, in the food service industry it is often necessary to maintain foods at high temperatures over relatively long periods of time. This is particularly true of thickener-containing foods such as gravies and soups. However, under these conditions an unmodified starch thickener is often unable to maintain a desirable viscosity. Moreover, after cooking and cooling foods containing an unmodified starch thickener, there is often an undesirable separation of fat or absorbed water from a previously homogeneous mix or emulsion. In addition, undesirable weeping and syneresis may occur, particularly after cold storage or freezing and thawing.

While thickeners employing modified starches do not possess these process tolerance limitations inherent to unmodified starches and/or flours, thickeners prepared from modified starches do not have the desirable cooked flour taste and appearance of thickeners prepared from unmodified starches and/or flours. As a result, the use of modified starch thickeners in foods often imparts a “synthetic” appearance as the foods are more translucent and have a glossy shine compared to foods prepared from unmodified starch and/or flour thickeners.

Various processes have been proposed for producing an ‘instant’ roux product that forms a roux upon the addition of liquid without the formation of lumps. For example, U.S. Pat. No. 4,568,551 discloses a process wherein a mixture of edible fat and starchy material is heat-treated together. This heat treatment can be optionally done either in the presence of added water or under elevated pressure. The heated product is cooled to form a solid, which is then grated to a powder for use as an instant roux. The starchy material is preferably flour, particularly wheat, rice or rye, but can also be granular, non-gelatinized starches. Modification of the starch is not taught. The fat component is edible fat, particularly high-melting edible fat having a melting point around 44° C. The fat content utilized is in the range of 30 to 60% by weight, and the starchy material generally ranges between about 25% and 80% by weight.

U.S. Pat. No. 5,895,676 teaches a process in which particulate farinaceous material is coated with molten fat in an enclosed coating zone. The molten fat is sprayed in the form of fine droplets onto the particles and cooled to form a flowable particulate product or binding agent. The resultant binding agent is readily dispersible in hot water. The farinaceous material preferably contains at least 50% by weight of flour, particularly wheat flour. Agglomerated starches such as potato starch, corn starch and wheat starch can be used in combination with the flour. The fat used is an edible, high melting point fat that has a melting point in the range of 40° to 45° C., such as hydrogenated palm oil fat. The resultant binding agent can be added to dried soup mixes, dried gravy mixes, dried sauce mixes and the like.

International Publication No. WO 98/03087 discloses a food thickener prepared by forming a mixture of starch and fat, and solidifying the mixture to form the food thickener. The fat is typically melted prior to mixing with the starch. The fats include any of a wide range of fats and oils, and are preferably selected from those having a steep melting curve, i.e., the transition from solid to liquid occurs over a narrow temperature range, preferably in the range of 35° C. to 50° C. The starch or starch-containing material is at least 70% starch and may include protein such as casein. Preferred starch materials are flours, including enzyme-inactivated flour, precooked flour, pregelatinized flour, dried or heat treated flour and synthetic flour. No modified or granular starches are taught or suggested by WO 98/03087. The liquid flour/fat mixture is atomized and then cooled to a powder.

European Patent No. 0 384 124 Bi discloses a process for preparing starch-containing, granular instant products, i.e., products that make possible a rapid and convenient preparation by boiling or stirring in water. The starch containing materials are mixed together without water and extruded. The starch-containing materials are preferably ground cereal products, particularly wheat flour, coarse wheat meal, corn meal, durum wheat flour or durum wheat semolina. The starch-containing materials can also include emulsifying agents such as lecithin and mono- and diglycerides, proteins such as whey or other milk proteins, flavorings and/or spices, and colorants. The powder from this extrusion can be used by itself as a sauce binder or can be mixed with a fat powder to form an instant roux. Fat powders preferably include those prepared by spray drying an emulsion of the fat. Fats exemplified included soybean oil and palm kernel oil. When mixed with the fat powder, the starch:fat ratio ranges from 50:50 to 90:10.

Japanese Patent No. 10 337 166 teaches a white roux prepared by mixing 40-60 weight % hydrogenated rape seed oil and fat with 40-60 weight % flour.

Still there is a need for an instant roux for use in cooking applications that provides the flavor, texture and color of a traditionally prepared roux as described above but in an easy-to-use, non-lumping, instant powder form. Further, there is a need for such an instant, powder-based roux that can be easily rehydrated or added directly to soups, sauces and other similar food products.

There is also a need for an instant roux for use in cooking applications that provides high quality thickened soups, sauces and the like that are smooth and velvety in texture while providing a home-made flavor comparable to sauces and soups made from a roux prepared in the traditional manner.

### SUMMARY OF THE INVENTION

The instant roux of the invention can be used in sauces, spreads, toppings, soups, fillings and gravies, including their dehydrated preparations that are hydrated by the consumer immediately prior to use. Thus, the instant roux of the present can be used as for thickening sauces and other liquid/semi-liquid foodstuffs upon the addition of a hot liquid, e.g., hot water, fond brun such as brown veal stock, milk, etc. The instant roux of the present invention can be easily dispersed in hot liquid without substantial lump formation, and has desirable organoleptic properties.

Thus, according to the present invention there is provided a process for producing a “ready-for-use” or instant roux comprising forming a co-processed mixture of flour and starch, and blending this thickening mixture with fat to form the instant roux. The co-processed mixture is prepared by blending at least one modified starch, particularly a stabilized and cross-linked or thermally inhibited starch, with at least one flour, particularly wheat flour, and co-processing the blend. Preferably, the co-processed material is present at a level of at least 50 weight % with respect to the fat, e.g., at a material:fat ratio of about 55:45 to 90:10. The material/fat mixture can be formed without added water.

The fat for use in the invention may comprise any of a wide range of fats or oils. In one aspect, the fats are selected from those which exhibit a steep melting curve, i.e., those fats wherein the transition from solid to liquid states occurs over a relatively narrow temperature range, e.g., over a range of 15° C. or less.

The nature of the fat can have a great influence on the characteristics of the roux powder. The fat used in the present invention is an edible fat. In one embodiment, the fat is a vegetable fat such as palm oil. Useful fats include both animal and vegetable fats. A useful example of an animal based fat is stearin. In one embodiment the fat is a hydrogenated vegetable oil. Useful hydrogenated fats include, e.g., cottonseed oil, soybean oil, rapeseed oil and mixtures thereof. Other useful fats include fat blends, such as the Beatreme® powdered vegetable shortenings available from Kerry Ingredients, Inc. These blends can include, for instance, a vegetable oil such as an hydrogenated vegetable oil, an emulsifier and/or stabilizer such as sodium caseinate, and nonfat milk solids.

The invention also contemplates an instant roux obtained by the process of the invention, as well as a foodstuff comprising such instant roux. Instant roux containing foodstuffs include dried food bases, particularly those for use in sauces, soups and gravies.

In yet another aspect of the invention there is provided a process for preparing a roux powder. This process involves forming a mixture of a co-processed thickener and fat to form a roux powder. The fat can be melted and then mixed with the thickener, preferably until the mixture is homogenous. This thickener/fat mixture can then be spray dried, with a consistent ratio of flour to fat achieved in the powder. The size of the particles can be controlled simply by the size of droplets formed upon atomization.

In an optional embodiment, flour can be added to the instant roux composition. The choice of flour also influences the nature of the roux powder significantly. Normally, flours contain at least 10% moisture, typically in the range 12 to 14% moisture. For the present invention, it has been found that flours with reduced moisture content form a superior roux powder, e.g., flours with less than 8% moisture. In another aspect, flours with moisture content less than 4% are used.

Optionally, other hydrocolloids such as pregelatinized or cold water swelling starches and/or modified starches can be added to enhance functionality of the roux, such as mouthfeel. Other functional additives may also be used, including emulsifiers such as lecithin, flavors such as butter flavor, colorants and proteins such as whey or casein or its salts. Other additives for enhancing the opacity of the roux, e.g., titanium dioxide, can be added.

The resultant roux compositions may advantageously be used as “ready-for-use” or instant roux having superior properties to roux prepared with flour and fat. The foods prepared from these roux have improved appearance, taste, process tolerance, emulsification, cold and hot temperature stability and instant viscosity properties compared to industry standard roux prepared from a combination of flour and fat.

### DETAILED DESCRIPTION OF THE INVENTION

This invention relates to an instant roux composition comprising a co-processed combination of modified starch and flour having desirable appearance, taste, process tolerance, emulsification, cold and hot temperature stability and instant viscosity properties and fat. In addition, the invention relates to the process for providing such “ready-for-use” compositions and the improved food products prepared from the co-processed compositions.

All starches and flours (hereinafter “starch”) derived from any native source may be suitable for use as the base starch herein. A native starch as used herein, is one as it is found in nature. Also suitable as the base starch are starches and flours derived from a plant obtained by standard breeding techniques including crossbreeding, translocation, inversion, transformation or any other method of gene or chromosome engineering to include variations thereof. In addition, starch or flours derived from a plant grown from artificial mutations and variations of the above generic composition which may be produced by known standard methods of mutation breeding are also suitable for use as the base starch as defined herein.

Typical sources for the base starches include cereals, tubers, roots, legumes and fruits. The native source can be corn, pea, potato, sweet potato, banana, barley, wheat, rice, sago, amaranth, tapioca, arrowroot, canna, sorghum, and waxy or high amylose varieties thereof. Sources of particularly useful base starches include tapioca, dent corn, waxy maize, potato, sago, and rice. As used herein, the term “waxy” includes a starch or flour containing at least about 95% by weight amylopectin, and the term “high amylose” includes a starch or flour containing at least about 40% by weight amylose.

The base starch will be subsequently modified unless the base starch is inherently stabilized as described infra, though an inherently stabilized starch may also be subject to subsequent modification. Base starches suitable for subsequent modification are also intended to include conversion products derived from any of the starches, including fluidity or thin-boiling starches prepared by oxidation, enzyme conversion, acid hydrolysis, heat and or acid dextrinization, thermal and or sheared products.

The base starch can be modified via a variety of known methods, provided the modification does not destroy the granular nature of the starch. The base starch may be treated by a combination of modifications in any order. As used herein, modified starches include, without limitation, crosslinked starches, thermally inhibited starches, stabilized starches, acetylated and organically esterified starches, hydroxyethylated and hydroxypropylated starches, phosphorylated and inorganically esterified starches, cationic, anionic, nonionic, and zwitterionic starches, and succinate and substituted succinate derivatives of starch. Such modifications and combinations thereof are known and their preparations are described in the art. For example, see Whistler, R. L., BeMiller, J. N. and Paschall E. F., Chpt. 9, § 3, Starch Chemistry and Technology, 2^{nd} Ed., Academic Press, Inc., London, pp. 324-349 (1984) and Modified Starches: Properties and Uses, Wurzburg, Editor, CRC Press, Inc., Florida (1986). Further, modification by thermal inhibition, such as that described in International Publication No. WO 95/04082, is also suitable for use herein.

The term “stabilized starch” includes starches wherein the base starch is substituted with one or more monofunctional chemical blocking groups, as well as base starches that inherently demonstrate stabilized properties. A base starch that demonstrates inherently stabilized properties is also defined to be a modified starch for the purposes of this application. Foods containing stabilized starches are characterized by the ability to substantially retain their texture (e.g., viscosity) and other desirable properties, such as color and clarity, during freeze/thaw cycling.

Examples of useful monofunctional substituted stabilized starches include, without limitation, starch esters and ethers, including starch acetates, starch octenyl succinate, starch phosphates, and starch hydroxy alkylates. The preparation and properties of such stabilized starches are known in the art and described, for example, in R. L. Whistler, J. N. BeMiller, and E. F. Paschall, Chpt. 9, § 5, pp. 343-349, Starch Chemistry and Technology, 2^{nd} Ed, Academic Press, Inc. London (1984), and R. L. Whistler and J. R. Daniel, Chpt 3, p. 119, Carbohydrates, Food Chemistry, 2^{nd} Ed., edited by O. R. Fenenma, Marcel Dekker, Inc., New York (1985).

Starches that are inherently stabilized (demonstrate stabilized properties without monofunctional substitution) include, without limitation, waxy maize starches having at least one recessive sugary-2 allele. An example of such a starch includes waxy maize starch derived from a plant having endosperm tissue that is heterozygous, with either one or two doses, for the recessive sugary-2 allele, described further in U.S. Pat. No. 5,954,883. Another example includes starch derived from a waxy maize plant of a wxsu2 (homozygous) genotype and translocations, inversions, mutants and variants thereof, discussed in U.S. Pat. No. 4,428,972.

Particularly useful modified starches are food quality starches in which the starch is dually modified by stabilizing and crosslinking the starch, or by stabilizing and thermally inhibiting the starch. In one aspect, useful stabilized and crosslinked starches include, for example, hydroxypropylated distarch phosphate, acetylated distarch adipate, and waxy maize starches having at least one recessive sugary-2 allele that are subsequently crosslinked or thermally inhibited. As used herein, food quality starches are starches that are edible by animals, including human beings.

Particularly useful hydroxypropylated distarch phosphates include those having a degree of substitution in the range of from about 3.5% to about 8.8%, preferably from about 5.7% to about 6.7% by weight of the bound propylene oxide on starch. Those distarch phosphates further have a degree of crosslinking from about 0.001% to about 0.04%, preferably from 0.01% to about 0.025% by weight of phosphorus oxychloride reagent used to crosslink the starch. Weight percents are by weight of the starch.

Flours that are particularly useful for preparing the instant roux of the present invention include, without limitation, wheat, tapioca, rye, oat, buckwheat and soybean flour, particularly wheat flour. Particularly useful wheat flours have less than 16% protein content, and especially useful wheat flours have less than 10% protein content.

In at least one embodiment, the process for obtaining the instant roux composition of the present invention includes the step of mixing or blending a modified starch with flour. In one embodiment, the blends are composed of modified starch to flour over a range of weight percent ratios of from about 72:28 to 93:7 starch to flour. In another embodiment, the blends include starches that are modified by both crosslinking and stabilizing and wheat flour in ratios of between about 80:20 to about 90:10 modified starch to flour.

With the materials mixed, the blend is then co-processed. Co-processing involves subjecting the blend to a spray-cooking or drum-drying process, thereby pregelatinizing the starch. An example of a useful spray-cooking process is the Steam Injection Dual Atomization (“SIDA”) process disclosed in U.S. Pat. Nos. 4,600,472 and 4,280,851. Another useful example is the spray-cooking process known as the “EK Process” disclosed in U.S. Pat. Nos. 5,131,953, 5,188,674, 5,281,432, 5,318,635, 5,435,851 and 5,571,552. The EK Process is a continuous coupled process in which starch slurry is jet-cooked, then conveyed at high temperature to a spray drier and spray dried.

In the SIDA process, a mixture of the granular starch is cooked or gelatinized in an atomized state. The starch which is to be cooked is injected as a starch slurry through an atomization aperture in the nozzle assembly into the spray of atomized steam so as to heat the starch to a temperature effective to gelatinize the starch. An enclosed chamber surrounds the atomization and heating medium injection apertures and defines a vent aperture positioned to enable the heated spray of starch to exit the chamber. The arrangement is such that the lapsed time between passage of the spray of starch through the chamber, i.e., from the atomization chamber and through the vent aperture, defines the gelatinization time of the starch. The resulting spray-dried pregelatinized starch comprises uniformly gelatinized starch in the form of indented spheres, with a majority of the granules being whole and unbroken and which swell upon rehydration. Nozzles suitable for use in the preparation of these starches are described in U.S. Pat. No. 4,610,760.

The steam injection/dual atomization process as referred to above may be more particularly described as pregelatinization of the starch by:
a) mixing the starch in an aqueous solvent,
b) atomizing the mixture with an enclosed chamber, and
c) interjecting a heating medium into the atomized mixture in the enclosed chamber to cook the starch, the size and shape of the chamber being effective to maintain the temperature and moisture control of the starch for a period of time sufficient to cook said starch. According to the present invention, the starch slurry can include the flour.

A steam injection/single atomization process for cooking and spray-drying starch is disclosed in the U.S. Pat. No. 5,149,799 patent referred to above and comprises:
a) slurrying the starch in an aqueous medium,
b) feeding a stream of the starch slurry at a pressure from about 50 to about 250 psig into an atomizing chamber within a spray nozzle,
c) injecting a heating medium into the atomizing chamber at a pressure from about 50 to about 250 psig,
d) simultaneously cooking and atomizing the starch slurry as the heating medium forces the starch through a vent at the bottom of the chamber, and
e) drying the atomized starch.

It is further noted that blends of the selected cross-linked starches may be used. Flour can also be slurried with the starch(es).

In those aspects where appropriate, small-scale modifications of the SIDA process may be used. One skilled in the art would recognize and know such modifications, an example of which is illustrated infra.

According to the SIDA process, the blend is initially mixed in an aqueous solvent (e.g., a slurry is formed) at the desired solids level and ratio of modified starch to flour. Typically, the desired solids level is between about 25% and about 43% by weight. In another embodiment, the solids level is between about 30 and about 35% by weight. The aqueous mixture is then atomized into an enclosed chamber forming a relatively fine spray that may be uniformly cooked or gelatinized. A heating medium can be interjected into the chamber to cook the material. Atomization of the slurry can be effectuated in a multi-fluid nozzle through which the slurry is conveyed, with steam (in this embodiment, the heating medium) interjected through the nozzle into the atomized material. This atomization process results in gelatinization of the blend.

After gelatinizing the atomized starch and flour material, the gelatinized mixture can be optionally transferred to a spray tower and dried from about 3% to about 12% moisture content by weight of the dried mixture.

After being subjected to the spray-cooking or drum-drying process, the processed material may optionally be agglomerated. Agglomeration may be achieved by methods known in the art, including, for instance, via batch or continuous processing. A particularly useful method of agglomeration involves spraying the material recovered from the spray tower with water until the individual particles adhere to one another. The particles are then dried with heated air to final moisture content of from about 3% to about 12%.

In one embodiment, the fat component of the instant roux is co-processed with the starch/flour blend. For example, when the SIDA process is used, the starch/flour blend can be atomized through one nozzle while the fat component is atomized through another nozzle. In this manner, the liquid fat droplets are mixed with the gelatinized starch/flour blend droplets.

In another embodiment, the fat component can be sprayed with the processed starch/flour blend during agglomeration. In this manner, the fat component can be used to adhere the co-processed starch/flour blend particles together.

The instant roux compositions of the present invention demonstrate a combination of desirable appearance and taste of conventional roux (i.e., roux prepared by cooking together equal portions of flour and butter), as well as process tolerance, emulsification, cold and hot temperature stability, and instant viscosity properties

Foods in which the instant roux of the present invention are useful include, without limitation, sauces, gravies, gumbos, etoufees, and instant type food products such as instant soups.

The following examples are presented to further illustrate and explain the present invention and should not be taken as limiting in any regard. All parts and percentages are given by weight and all temperatures in degrees Celsius (° C.) unless otherwise noted.

### EXAMPLES

### Example 1

Process for Preparing Co-Processed Thickening Compositions

A modified starch was prepared by stabilizing with propylene oxide to a degree of from about 5.7% to about 6.7% based on dry weight % starch, and crosslinking with phosphorus oxychloride from about 0.01% to about 0.025% based on dry weight % starch. The base starch used was waxy maize. This process of modification resulted in a hydroxypropylated distarch phosphate. This modified starch (28.3 kg) was mixed with commercially available wheat flour (5.0 kg) and sufficient water in a batch tank so that dilatancy does not occur. The resultant slurry was uniformly mixed with a Lightnin® Classic Mixer (Rochester, N.Y.).

This starch/flour mixture was then subjected to a small-scale modified steam injection dual atomization (“SIDA”) spray-cooking process. Spray cooking was effected by a ¼ J-system comprising an air-atomizing nozzle in combination with air and fluid caps. The uniform slurry was pumped at 140 psi into the air cap and gelatinized via steam at 135 psi. This resultant steam-pressurized and gelatinized mixture was then atomized through orifices in the cap. The liquid particles were dried as they dropped through the spray tower (associated with the ¼ J-system) in air at a temperature of 236° C. and recovered as a pregelatinized dry powder. The moisture content of these dry powders was from about 3% to about 12% by weight of the co-processed thickening composition.

The dried mixture was then agglomerated by fluidizing it in a fluidized bed at a temperature of 90° C. while spraying water onto the dried mixture until the individual particles adhered to one another and a loose bulk density of 0.18 to 0.35 grams/cc was achieved.

Process for Preparing Non-Instant Roux using the Co-processed Thickening Composition

Non-instant roux were prepared by blending the above co-processed thickening composition with a variety of stearins or fats in various ratios to determine the preferred combination. The blends were compared against a real roux, i.e., an equal blend of butter and flour, a diluted real roux containing 17% solids, a commercially available white sauce mix containing 11% solids (available from Knorr, a division of Unilever Bestfoods, Englewood Cliffs, New Jersey), and a commercially available brown gravy mix containing 11% solids (available from Knorr, a division of Unilever Bestfoods, Englewood Cliffs, New Jersey).

### Examples 1a-1d

The following tables 1a-1d illustrate the various fats tested and the ratio of fat to thickening composition used—

TABLE 1a
Butter as fat

| Ingredient | Amount of Ingredient (%) | | |
|---|---|---|---|
| Butter | 12.5 | 26.3 | 41.6 |
| Thickener of | 87.5 | 73.7 | 58.3 |
| Example 1 | | | |

The butter was melted and added to the thickener. Each butter/thickener blend provides a good roux with good smell. However, because the process requires the step of melting the butter and adding that melted butter to the thickener, it is not considered an instant or ready-to-use roux for purpose of the present invention.

TABLE 1b
Partially Hydrogenated palm oil as fat

| Ingredient | Amount of Ingredient (%) | | |
|---|---|---|---|
| Palm Oil | 12.5 | 26.3 | 41.6 |
| Thickener of | 87.5 | 73.7 | 58.3 |
| Example 1 | | | |

This blended product becomes grainy, especially after cooling. The product is also grainy if it is not cooked enough.

TABLE 1c
Dried vegetable oil as fat
(Dritex ®, available from HUMKO Oil Products, Cordova, TN)

| Ingredient | Amount of Ingredient (%) | | |
|---|---|---|---|
| Vegetable Oil | 12.5 | 26.3 | 41.6 |
| Thickener of | 87.5 | 73.7 | 58.3 |
| Example 1 | | | |

This particular fat did not blend with the thickener, i.e., no emulsification. The fat separated on top of the thickener.

TABLE 1d
Powdered vegetable shortening containing hydrogenated soybean
oil and milk protein (sodium caseinate) (Beatreme) as fat

| Ingredient | Amount of Ingredient (%) | | |
|---|---|---|---|
| Beatreme | 12.5 | 26.3 | 41.6 |
| Thickener | 87.5 | 73.7 | 58.3 |

This blend produced the most opaque product with best taste.

### Example 2

Fat-Free Instant Roux

A fat-free powder blend instant roux was prepared as follows. A blend of 44.4% flour (commercially available wheat flour), 30% co-processed thickening composition according to Example 1, and 25.6% maltodextrin (pregelatinized tapioca maltodextrin, available as Instant Oil II, National Starch and Chemical Company, Bridgewater, N.J.) was prepared. The blend was added to heated water to produce a roux. The fat-free roux had good color, but had a powdery taste.

### Example 3

Instant Roux with Emulsifier

A variety of instant roux powders were prepared using several different emulsifiers. The product composition and results are provided in the following Tables 3a-3c.

TABLE 3a
Modified Starch as emulsifier

| Ingredient | Amount (%) |
|---|---|
| Flour | 18.2 |
| Thickener of | 29.7 |
| Example 1 | |
| Fat (stearin) | 42.5 |
| Modified starch | 9.6 |

The starch used was modified waxy maize, available as N-Creamer™ 46 from National Starch and Chemical Company, Bridgewater, N.J. The fat was not stable in the blend, resulting in poor emulsifying properties and a grainy texture.

TABLE 3b
Soy lecithin as emulsifier

| Ingredient | Amount (%) |
|---|---|
| Flour | 18.2 |
| Thickener of | 36.4 |
| Example 1 | |
| Fat (stearin) | 21.2 |
| Soy lecithin | 6 |

This instant roux product provided good emulsification with a good product.

TABLE 3c
Whey protein as emulsifier

| Ingredient | Amount (%) |
|---|---|
| Flour | 18.2 |
| Thickener | 36.4 |
| Fat (stearin) | 21.2 |
| Whey protein | 6 |

This instant roux product provided good emulsification with a good product.

### Example 4

All dry mixes were compared to both the gold standard, i.e., real roux (50% butter and 50% flour), and the white Knorr roux mentioned in Example 1 supra (hydrogenated oil and flour). The mixes were evaluated for the following characteristics:
Easiness of dispersion in hot water (lumps or no lumps)
Speed of hydration (short, long) to reach full viscosity
Stability on a hot table over time (0, 2, 6 hours) with Brookfield viscosity measurement with a Brookfield
Stability after refrigeration at 4° C. (after 3 days) with syneresis or not

Using a ratio of 30% fat to 70% thickener of Example 1, with viscosity adjusted to be equal in each, the following results were determined —

TABLE 4a
Comparison of Hydration and Dispersion

| | Speed of | Easiness of |
|---|---|---|
| Cooking | Hydration | dispersion |
| Real roux | Long | easy |
| Thickener of | short | A bit stirring |
| Example 1 + Stearine | | required |
| as fat | | |
| Thickener of | short | A bit stirring |
| Example 1 + Beatreme | | required |
| 2784 | | |
| Thickener of | short | A bit stirring |
| Example 1 + Centenial 1 | | required |
| Knorr roux | Long | easy |

Hydration to reach equal viscosity was never fully reached with the real roux and Knorr product (flour-containing bases). It is reached during the holding on a steam table (see below). The thickener of Example 1 is hydrating in the mixes nearly instantaneously—it only needs to be held for 45 seconds at 90° C. to reach full viscosity. In one aspect, the instant roux compositions should be stirred initially to avoid too rapid hydration and formation of lumps.

TABLE 4b
Steam Table Stability

| Steam table stability | T = 0 | T = 2 hours | T = 6 hours |
|---|---|---|---|
| Real roux | 8150 | 12060 | 6000 |
| Thickener of Example | 8000 | 8120 | 8310 |
| 1 + Stearine | | | |
| Thickener of Example | 7950 | 8100 | 8070 |
| 1 + Beatreme 2784 | | | |
| Thickener of Example | 7890 | 8010 | 7990 |
| 1 + Centenial 1 | | | |
| Knorr roux | 8430 | 10400 | 7050 |

Average of 3 viscosity measurements (cP) on a Brookfield, 15 sec, spindle 04, rpm 10, at 70° C.

The real roux and Knorr mix first increase in viscosity (as the flour is yet not fully cooked) and then breakdown over time. In contrast, the instant roux compositions of the present invention do not break down over time. The instant roux reached full viscosity at t=0 and remained stable overtime.

TABLE 4c
Effect on Syneresis

| Refrigeration | Syneresis |
|---|---|
| Real roux | ++ |
| Thickener of Example | 0 |
| 1 + Stearine | |
| Thickener of Example | 0 (smoother) |
| 1 + Beatreme 2784 | |
| Thickener of Example | 0 (smoother) |
| 1 + Centenial 1 | |
| Knorr roux | ++ |

Retrogradation of the amylose contained in the flours produces visible syneresis. In contrast, the instant roux did not retrograde. The instant roux with emulsifier provides a product that is more opaque and smoother, with both phases (fat and oil) holding together better than the real roux and Knorr mix.

Various powdered caramel colors were added to a blend of 87.5% of the thickener of Example 1 and 12.5% fat. A range of colors were created that mimic various degrees of cooking of a real roux. Titanium dioxides was also added to improve opacity.

Various types of commercially available powdered flavors were added to a blend of 87.5% of the thickener of Example 1 and 12.5% fat. These included, e.g., Butter Buds® (from Butter Buds Food Ingredients, Racine, Wis.), and Edlong® lipolytic butter flavor, cooked butter flavor and toasted butter flavor (from Edlong® Flavors, Elk Grove Village, Ill.). A range of flavors were created.

What is claimed is:

1. A ready-to-use roux composition comprising a processed thickener and fat.

2. The roux composition of claim 1 wherein the processed thickener further comprises starch and flour.

3. The roux composition of claim 2 wherein the starch is a modified starch.

4. The roux composition of claim 3 wherein the modified starch is a crosslinked starch.

5. The roux composition of claim 3 wherein the modified starch is a thermally inhibited starch.

6. The roux composition of claim 2 wherein the starch is a stabilized starch.

7. The roux composition of claim 6 wherein the stabilized starch is a hydroxyalkylated distarch phosphate or an acetylated distarch adipate.

8. The roux composition of claim 2 wherein the flour is wheat flour having a protein content of less than about 16%.

9. The roux composition of claim 8 wherein the flour is wheat flour having a protein content of less than about 10%.

10. The roux composition of claim 2 wherein the starch and the flour are present in a ratio of from about 72:28 to about 93:7 by weight, respectively.

11. The roux composition of claim 10 wherein the starch and the flour are present in a ratio of from 80:20 to about 90:10 by weight, respectively.

12. The roux composition according to claim 3 wherein the modified starch is a dihydroxypropylated distarch phosphate waxy maize starch substituted to a degree of from about 5.7% to about 6.7% by weight of propylene oxide reagent used to stabilize the starch.

13. The roux composition according to claim 12 wherein the modified starch is a crosslinked starch substituted from about 0.01% to about 0.025% by weight of phosphorus oxychloride reagent used to crosslink the starch.

14. The roux composition according to claim 2 wherein the flour is wheat flour having 10% protein content, and the starch and the flour are present in a ratio of 85:15 wt % starch to flour.

15. The roux composition according to claim 14 wherein the starch and flour are co-processed via the SIDA process.

16. A food product comprising the roux composition of claim 1.

17. The food product of claim 16 wherein the food is selected from the group consisting of sauces, gravies, gumbos, etoufees, and instant food products.

18. A process for preparing a ready-to-use roux composition for use in foods comprising the steps of:
creating a slurry of starch and flour,
coprocessing the starch/flour slurry so as to gelatinize at least part of the starch,
drying the gelatinized starch/flour blend to form a coprocessed thickener, and
blending the coprocessed thickener with a fat.

19. The process according to claim 18 wherein the starch and flour are co-processed via the SIDA process.

20. The process according to claim 18 further comprising blending the coprocessed thickener and fat with flour.

21. The process according to claim 18 further comprising blending the coprocessed thickener and fat with at least one emulsifier.

22. The process according to claim 18 further comprising blending the coprocessed thickener and fat with at least one dye.

23. The process according to claim 18 further comprising blending the coprocessed thickener and fat with at least one flavor.
